(19) United States
(12) Patent Application Publication
(10) Pub. No.: US 2015/0074932 A1
(43) Pub. Date: Mar. 19, 2015

(54) CLEANING BODY

(71) Applicant: JÖST GmbH, Wald-Michelbach (DE)

(72) Inventor: Peter Jöst, Abtsteinach (DE)

(21) Appl. No.: 14/474,782

(22) Filed: Sep. 2, 2014

(30) Foreign Application Priority Data
Sep. 13, 2013 (DE) 20 2013 008 136.8

(51) Int. Cl. A47L 13/16; B32B 38/00; B32B 37/18; B32B 37/12

(52) U.S. Cl. CPC A47L 13/16; B32B 37/12; B32B 38/0012; B32B 38/0004; B32B 37/18
USPC 15/244.4; 156/256

(57) ABSTRACT

Apparatus and Method for manufacturing a cleaning body 1, consisting of a first plate 10 made of melamine resin foam and a second plate 20 made of melamine resin foam, wherein the first plate 10 comprises at a first side 12 thereof a burled surface and the second plate 20 comprises at a first side 22 thereof a burled surface, wherein the first plate 10 is adhered at the burled surface of the first side 12 by means of at least one adhesive layer 30 with the burled surface of the first side 22 of the second plate 20.

### FIELD OF THE INVENTION

The present invention relates to a cleaning body with layers made of melamine resin foam. Such cleaning bodies are used as so called “dirt erasers” due to their slightly abrasive properties. Due to their good cleaning performance, such cleaning bodies preferably can also be used for the machine based cleaning of floorings, comprising different materials and surface structures.

### PRIOR ART

Cleaning bodies made of melamine resin foam are used as all purpose “dirt erasers” and for cleaning of floorings with plane and structured surfaces, like for instance made of polymer, tiles, ceramics, hard surface floorings and natural stone floorings. The cleaning effect is caused by the fact that the cleaning bodies work like smooth sandpaper due to their slight abrasive property. The abrasive property is caused by the fact that the cleaning bodies made of melamine resin foam are hard like glass contrary to other foams in spite of their fine open cell structure and bendability. When the melamine resin foam is wetted with water, the melamine resin foam gets sliding properties and thus is also able to remove strong dirt at the surfaces.

The cleaning bodies can in particular comprise one side with a profiled surface, for instance with resilient burls and thus can enter deeper areas of the surface of structured floorings and can clean them carefully, intensively and effectively. Such cleaning bodies are already known from the published patent application DE 10 2010 029 128 A1.

However, the life time of cleaning bodies made of melamine resin foam is a problem, which has not been solved in an optimal way up to now. The cleaning side shows high abrasion during use in particular when having a profiled surface. The present invention thus solves the problem to provide a cleaning body, which comprises lower abrasion than the prior art, without reducing the cleaning effect of the melamine resin foam.

### SUMMARY OF THE INVENTION

The above mentioned problem is solved by a cleaning body according to claim 1 as well as by a method according to claim 15. In particular, the above mentioned problem is solved by a cleaning body, comprising a first plate made of melamine resin foam and a second plate made of melamine resin foam, wherein the first plate comprises at a first side thereof a burled surface and the second plate comprises at a first side thereof a burled surface, wherein the first plate is adhered at the burled surface of the first side by means of at least one adhesive layer with the burled surface of the first side of the second plate. By the toothing of the burls of the first and second plates and its adhesion by means of an adhesive layer, the cleaning body becomes all in all more solid, pressure stable, bendable and tear resistant and thus shows an increased handling strength. Without limiting the claimed invention to any particular theory of operation, it is believed that the adhesive infuses into the openings in the fine-scale open cell structured melamine foam and thus reinforces it. Thus the adhesive and melamine foam synergistically form a composite material that has unexpectedly significant improved abrasion resistance over plain melamine foam.

Moreover, due to the burling of the adhesive areas the surface is increased, so that the adhesion is mechanically very firm. Moreover, the cleaning body comprises due to the adhered plate structure with at least two layers an increased life time. The three dimensional adhesive layer between the melamine resin plates, which are toothed into one another, forms a framework, which elastically supports and strengthens the melamine resin foam. Thus, the melamine resin foam does not disintegrate during the use as strong as cleaning bodies known from the prior art. Thus, the cleaning and abrasive effect of the melamine resin foam is maintained for a significantly longer time than for common single layered melamine resin cleaning bodies.

Preferably, the adhesive layer comprises cold curing synthetic resin. The first and the second plates can be adhered to each other by means of different materials. Preferably, the adhesion is carried out by means of a cold curing synthetic resin, since the melamine resin plates work like isolation layers and thus no heat impact to the adhesive layer can be realized. By the cold curing synthetic resin an inseparable adhesion of the two plates is generated.

Preferably, the adhesive layer moreover comprises a reinforcing layer of viscose fiber fleece, synthetic fiber fleece or fabric or combinations thereof. In addition to the synthetic resin or the melting layer, further materials can be added to the adhesive layer for an improved solidification and stabilization of the melamine resin foam. These fleeces and fabrics additionally harden the adhesive layer and all in all make the cleaning body even more firm, tear resistant and long lasting. Fleeces and fabrics work as a kind of reinforcement for the cleaning body.

Preferably, the burled surfaces of the first sides of the first and second plates are realized complementarily to each other. By the complementarities of the burls and the adhesion of the burled complementary surfaces, the adhesive layer comprises a homogenous thickness and the toothing of the plates is particularly firm. This all in all makes the cleaning body more stable during use.

Preferably, the first plate and the second plate are generated together out of a single source plate by a common burling cut. The single plates can be made of a single source plate, when in a common burling cut a specific burling of the two resulting plates is generated, wherein the burling is complementary to each other. Of course it is possible to cut a single source plate also by corresponding burling cuts into three or more plates, in order to generate a three or more layered cleaning body after the succeeding adhesion.

Preferably, the cleaning body comprises a first side with a profiled surface. The profiled surface is in particular suitable, in order to reach deeper areas of a structured surface to be cleaned and also to clean these deeper areas thoroughly and effectively. Preferably, the profiled surface of the first side of the cleaning body comprises resilient burls, wherein the burls comprise a pyramid shape, a pyramid frustum shape, a cone shape, a cone frustum shape or in cross section a wave shape. The resilient burls are in particular well suited in order to reach deeper areas of a structured surface to be cleaned and also to clean in these areas thoroughly and effectively. For the pyramid shape and the cone shape in comparison pointed shapes of the burls result, so that fine structured floorings can be cleaned in a better manner. For the pyramid frustum shape and the cone frustum shape, a flattened tip results, which is advantageous for more roughly structured floorings, in particular also for burled floorings. For the wave shape in cross section, the burls comprise a rounded tip and then lead into a more stump-like burl area. Thus, they are suitable both for fine and more rough structured floorings.

Preferably, the cleaning body comprises a second side with a plane surface. At this second side, the cleaning body can be fixed to a cleaning machine. For instance for the cleaning of floorings, a floor cleaning machine with a brushed disc may be placed onto this side.

Preferably, the cleaning body moreover comprises a hook and loop adaption layer, which is fixed at the second side of the cleaning body. By means of the hook and loop adaption layer the cleaning body can be safely fixed to a grinding disc or a grinding plate of a grinding or cleaning machine. Thus, the cleaning body can be also used for the machine based cleaning by means of such machines.

Preferably, the cleaning body comprises further plates made of melamine resin foam comprising first and second burled surfaces, which are adhered to the first or the second plate and with each other by further adhesive layers. The cleaning body according to the invention consists of at least two plates, which are toothed with each other and which are adhered with each other, and is thus at least two layered. In order to further increase the stability of the cleaning body or its thickness, further plates with the specific adhesive layers can be added in order to generate a three or more layered cleaning body.

Preferably, the melamine resin foam consists of an open cell and abrasive foam material. This material has been proven to be particular advantageous. The fine-scale three-dimensional open cell structure consisting of slim and easily deformable bars of the melamine resin foam, provide a slightly abrasive effect without the necessity of additional abrasive particles.

Preferably, the plates comprise a maximum thickness of 4 mm-60 mm, preferably of 10 mm-30 mm. Due to the thickness of the plates, the resilience of the plates and the distance of the adhesive layers is insured. The thickness of the plates thus also defines the stability and durability of the cleaning body.

Preferably, the cleaning body is realized as a round cleaning disc or as a rectangular cleaning pad or as a cleaning sponge. The single plates of the cleaning body may comprise different thicknesses, distances and also shapes, like for instance round or square. Depending on the properties of the objects to be cleaned (like for instance the floor properties) and the cleaning intension, corresponding shapes of the cleaning bodies, different numbers of plates, different burl heights or different material properties may be advantageous.

Preferably, the at least one adhesive layer comprises abrasive particles, in particular abrasive particles with a grit size of 500-1000. Therefore, also then a cleaning effect is provided, when the melamine resin foam is disintegrated down to the adhesive layer and the adhesive layer comes into contact with the surface to be cleaned. Then, the cleaning body cleans the surface to be cleaned with a combination of the melamine resin foam between a framework of the also abrasive adhesive layer.

The above mentioned problems are also solved by a method for manufacturing of a cleaning body, comprising the following steps:
a. inserting a single source plate made of melamine resin foam into a burling machine;
b. compressing the source plate between two burl drums of the burling machine;
c. cutting of the source plate in the compressed state by means of at least one cutting knife into at least two plates; and
d. adhering the at least two plates at the burled surfaces, which are complementary to each other by means of an adhesive layer.

Hereby an advantageous cleaning body is provided, which is all in all more firm, pressure stable, flexible and tear resistant and thus comprises an improved handling strength due to the toothing of the burls of the first and second plates and their adhesion by means of an adhesive layer. Moreover, by the burling of the adhesion areas, the surface is increased so that the adhesion is mechanically very firm. Due to these measures, all in all, the life time of the cleaning body is significantly increased in view of an ordinary cleaning body made of melamine resin foam.

### BRIEF DESCRIPTION OF THE DRAWINGS

In the following, preferred embodiments of the present invention are described by means of the accompanying drawings, in which shows:

FIG. 1: an embodiment of a cleaning body according to the invention in a perspective view;

FIG. 2: a further embodiment of a four layered cleaning body in a perspective view;

FIG. 3: a perspective detailed view of a further embodiment of a three layered cleaning body with a hook and loop adaption layer and a structured surface; and

FIG. 4A-4D: perspective detailed views of differently structured surfaces of embodiments of a cleaning body according to the invention.

### DESCRIPTION OF THE PREFERRED EMBODIMENTS

In the following, preferred embodiments of the invention will be described by means of the accompanying figures. Features of single embodiments can be also combined with features of other embodiments, even if such combinations are not mentioned in detail in individual cases.

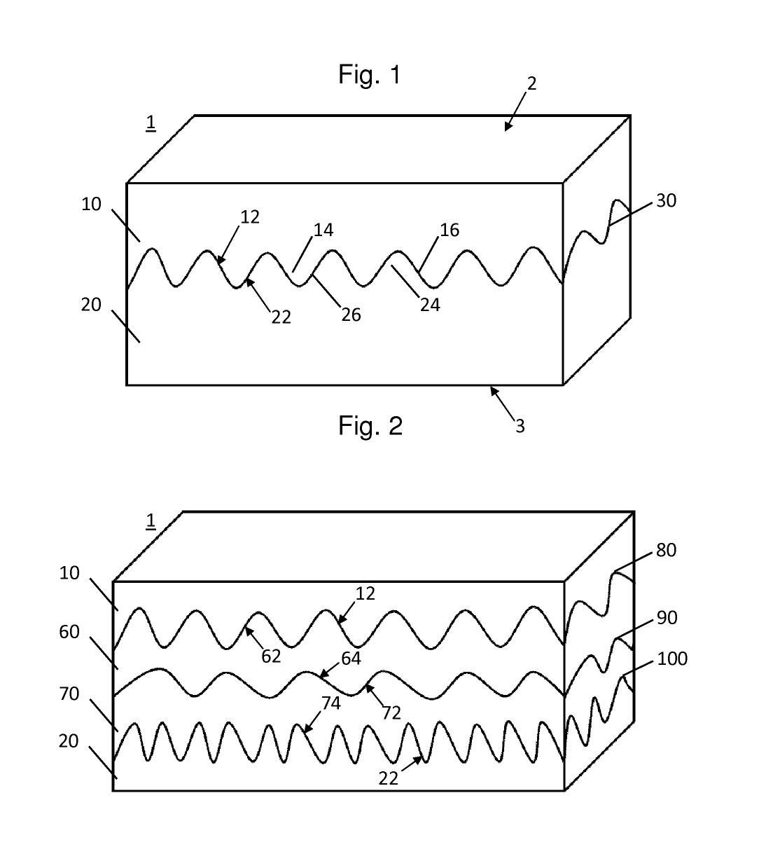

FIG. 1 shows a cleaning body 1 according to the invention in a two layered setup. The cleaning body 1 comprises a first plate 10 and a second plate 20 made of melamine resin foam, wherein the first plate 10 and the second plate 20 each comprise a first side 12, 22 with a burled surface. The burled surface of the first side 12, 22 comprises burls 14, 24, which are preferably arranged at the surface in an equally distributed manner. Preferably, the burls 14, 24 comprise in cross section a wave shape and are designed complementarily to each other. Hereby, for instance the burl 14 of the first plate 10 fits without a gap in a burl valley 26 of the second plate 20.

Preferably, all burls of the first side 12, 22 of one of the plates 10, 20 fit into corresponding burl valleys 16, 26 of the first side 12, 22 of the other plate 10, 20. Thus, the plates 10, 20 can be fitted together at their first sides without any gap and can be adhered together. The burled surfaces of the first sides 12, 22 are thus realized complementarily to each other.

Such burled surfaces of the plates 10, 20, wherein the burled surfaces are realized complementarily to each other, can be generated in the most simple way by one common burling process. The burling process is carried out as follows:
a. inserting a single source plate made of melamine resin foam into a burling machine;
b. compressing the source plate between two burl drums of the burling machine; and
c. cutting the source plate in the compressed state by means of at least one cutting knife into at least two plates 10, 20.

By the common burling step in a burling machine, two plates 10, 20 with surfaces, which are complementarily burled to each other, are generated. These at least two plates 10, 20 are then adhered to each other in the toothed state, in order to generate a cleaning body 1 according to the invention.

During the adhering step, the complementary and burled surfaces of the first sides 12, 22 are connected to each other by an adhesive layer 30. The adhesive layer 30 can comprise a suitable synthetic resin. A cold curing synthetic resin has been proven as adhesive layer 30, since it does not need any heat impact in order to cure.

For strengthening the adhesive layer 30, during the adhering process a viscose fleece, a synthetic fiber fleece, a fabric or combinations thereof can be inserted between the plates 10, 20 into the adhesive layer 30. These additional fleeces or fabrics work as a reinforcement and furthermore strengthen the cleaning body 1. This is in particular advantageous, since the melamine resin foam of the plates 10, 20 consists of an open cell and abrasive foam material, which comprises particularly good cleaning properties, but which itself is very brittle and which comprises a low mechanical resistance and which is thus quickly worn out. By the adhesive layer 30 and optionally by the reinforcement made of fleeces and fabrics, the life time of the melamine resin foam of the cleaning body 1 is significantly increased.

The adhesive layer 30 can also comprise abrasive particles, and can be in particular mixed with abrasive particles, in order to increase its cleaning effect. Also such an abrasive adhesive layer can be applied by a pouring method on one of the burled surfaces 12, 22 to be adhered. Preferably, fine abrasive particles with a grit size of 500-1000 are used. In that way also then a cleaning effect is insured, when the melamine resin foam 10, 20 is disintegrated down to the adhesive layer 30 and the adhesive layer 30 gets into contact with the surface to be cleaned. By doing so, the cleaning body 1 then cleans the surface to be cleaned with a combination of the melamine resin foam 10, 20 between a framework of the also abrasive adhesive layer 30.

The cleaning body 1 of FIG. 1 comprises sides 2, 3 with plane surfaces. Thus, it is for instance suitable as dirt eraser and for the cleaning of plane surfaces.

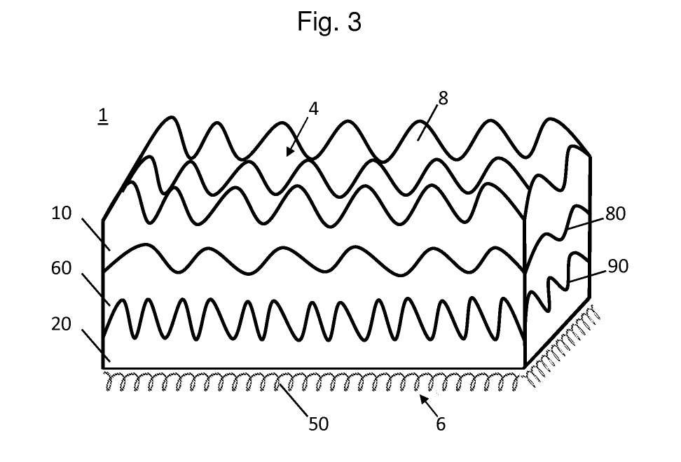

Alternatively, the sides 2, 3 of the cleaning body 1 can also comprise a profiled surface 4, as it is shown in FIG. 3 for the side 2. Such a cleaning body 1 is in particular suitable for the cleaning of structured surfaces, like for instance of structured floorings. The profiled surface 4 can also get into contact with deeper areas of the structured surfaces to be cleaned and is thus in particular suitable for cleaning these deep areas thoroughly and effectively.

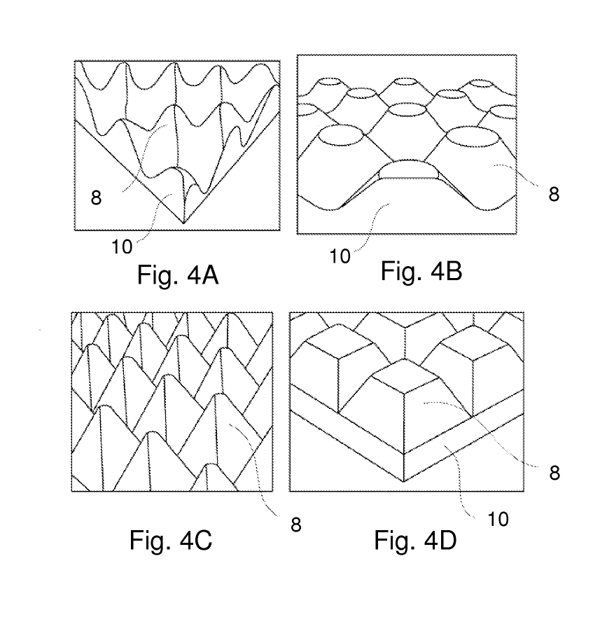

Preferably, the profiled surface 4 comprises burls 8, wherein the burls 8 can comprise different burl shapes, like they are for instance shown in FIG. 4. Herein, FIG. 4A shows burls 8, which in cross section comprise a wave shape, wherein in FIG. 4B burls are shown, which comprise a cone frustum shape, wherein in FIG. 4C burls are shown, which comprise a pyramid shape, and wherein in FIG. 4D burls 8 are shown, which comprise a pyramid frustum shape. By the choice of shape and size of the burls 8, the cleaning body 1 can be adapted to the cleaning task, in particular to the surface structure of the object to be cleaned, like for instance of a structured flooring, in an optimum manner. For the cleaning of a polymer flooring with shale structure advantageously a more pointedly realized burl shape will be chosen, like for instance a pointed pyramid structure or cone structure, whereas for the cleaning of a flooring with hammer blow structure or a structure with round burls, a burl 8 will be used, which is at its tip more rounded.

FIG. 2 shows a further preferred embodiment of a cleaning body 1 according to the invention. In this embodiment, the cleaning body 1 comprises a four layered setup. Correspondingly, it comprises besides a first plate 10 and a second plate 20 made of melamine resin foam there between two further middle plates 60, 70 made of melamine resin foam. As it is shown schematically in FIG. 2, the middle plates 60, 70 comprise two opposed sides with burled surfaces 62, 64 and respectively 72, 74, at which they are adhered with the burled surfaces of the sides 12, 22 of the adjacent plates 10, 20. The middle plate 60 comprises in that case a common adhesive layer 80 with the first upper plate 10 and a common adhesive layer 100 with the middle plate 70. The other middle plate 70 comprises a common adhesive layer 90 with the lower plate 20 and a common adhesive layer 100 with the middle plate 60.

FIG. 3 shows a preferred three layered cleaning body 1 with three layers respectively plates 10, 20, 60 made of melamine resin foam. Also herein, the layers respectively plates 10, 20, 60 are burled, wherein the burls are realized complementarily to each other, and are adhered at the burled surfaces with each other by means of adhesive layers.

By the multi layered setup of the cleaning body 1, the cleaning body 1 will—in spite of a larger total thickness—become particularly firm and durable by the interlayered adhesive layers 30, 80, 90, 100. The plates preferably comprise a maximum thickness of 5 mm-60 mm, preferably of 5 mm-30 mm. Thus, the cleaning body 1 preferably comprises a total thickness of 10 mm-80 mm.

Furthermore, the cleaning body 1 can comprise a side 3 with a plane surface 6, which can be provided with a hook and loop adaption layer 50. In FIG. 3, the hook and loop adaption layer 50 is for instance fixed at the lower side of a preferred three layered cleaning body 1 with three plates made of melamine resin foam 10, 20, 60. By means of the hook and loop adaption layer 50, the cleaning body 1 can be fixed to a floor cleaning machine, in particular to a plate of a floor cleaning machine. The cleaning body 1 can be also fixed by the use of the hook and loop adaption layer 50 to a grinding disc of a rotary grinding machine. Thus, the cleaning body 1 can be in particular used for the machine based cleaning of structured objects and structured floorings.

A cleaning body 1 according to the invention with layers made of melamine resin foam can also comprise further layers, which do not consist of melamine resin foam. Thus, in particular cleaning bodies can be provided, which enclose use layers made of melamine resin foam and support layers made of another material

Although certain illustrative embodiments and methods have been disclosed herein, it will be apparent from the foregoing disclosure to those skilled in the art that variations and modifications of such embodiments and methods may be made without departing from the invention. Accordingly, it is intended that the invention should be limited only to the extent required by the appended claims and the rules and principles of applicable law. Additionally, as used herein, references to direction such as “up” or “down” are intend to be exemplary and are not considered as limiting the invention and, unless otherwise specifically defined, the terms “generally,” “substantially,” or “approximately” when used with mathematical concepts or measurements mean within ±10 degrees of angle or within 10 percent of the measurement, whichever is greater, and as used herein, a step of “providing” a structural element recited in a method claim means and includes obtaining, fabricating, purchasing, acquiring or otherwise gaining access to the structural element for performing the steps of the method.

### LIST OF REFERENCE SIGNS

1 cleaning body
2, 3 side of the cleaning body
4 first side with a profiled surface
6 second side with a plane surface
8 burls
10 first plate made of melamine resin foam
12 first side of the first plate with burled surface
14 burl
16 burl valley
20 second plate made of melamine resin foam
22 first side of the second plate with burled surface
24 burl
26 burl valley
30 adhesive layer between the burled surfaces of the first and second plates
50 hook and loop adaption layer
60 middle plate made of melamine resin foam
62, 64 burled surface
70 middle plate made of melamine resin foam
72, 74 burled surface
80, 90, 100 adhesive layer

What is claimed is:

1. A cleaning body (1), comprising:
a first plate (10) made of melamine resin foam; and
a second plate (20) made of melamine resin foam,
wherein the first plate (10) comprises at a first side (12) thereof a burled surface and the second plate (20) comprises at a first side (22) thereof a burled surface, wherein the first plate (10) is adhered at the burled surface of the first side (12) to the burled surface of the first side (22) of the second plate (20) by means of at least one adhesive layer (30).

2. Cleaning body according to claim 1, wherein the adhesive layer (30) comprises a cold-curing synthetic resin.

3. Cleaning body according to claim 2, wherein the adhesive layer (30) further comprises a reinforcing layer chosen from the group consisting of a viscose fiber fleece, synthetic fiber fleece, viscose fiber fabric, synthetic fiber fabric and combinations thereof.

4. Cleaning body according to claim 1, wherein the burled surfaces on the first sides (12, 22) of the first and second plates (10, 20) are complementarily to each other.

5. Cleaning body according to claim 1, wherein the first plate (10) and the second plate (20) are generated by one common burling cut out of one single source plate.

6. Cleaning body according to claim 1, wherein the cleaning body (1) comprises a first side (4) with a profiled surface.

7. Cleaning body according to claim 6, wherein the profiled surface of the first side (4) of the cleaning body (1) comprises resilient burls (8), wherein the burls (8) comprise a pyramid shape, a pyramid-frustum shape, a cone shape, a cone frustum shape or in cross section a wave shape.

8. Cleaning body according to claim 1, wherein the cleaning body (1) comprises a second side (6) with a plane surface.

9. Cleaning body according to claim 1, further comprising a hook and loop attachment layer (50), which is fixed at the second side (6) of the cleaning body (1).

10. Cleaning body according to claim 1, further comprising additional plates (60, 70) made of melamine resin foam, with first and second burled surfaces (62, 64, 72, 74), which are adhered to the first or the second plate (10, 20) ant to each other by further adhesive layers (80, 90, 100).

11. Cleaning body according to claim 1, wherein the melamine resin foam consists of an open cell and abrasive foam material.

12. Cleaning body according to claim 1, wherein the plates (10, 20, 60, 70) comprise a maximum thickness of 4 mm-60 mm, preferably of 10 mm-30 mm.

13. Cleaning body according to claim 1, wherein the cleaning body (1) is realized as a round cleaning disk or as a rectangular cleaning pad or as a cleaning sponge.

14. Cleaning body according to claim 1, wherein at least one adhesive layer (30, 80, 90, 100) comprises abrasive particles, in particular abrasive particles with a grit size of 500-1000.

15. Method for manufacturing a cleaning body (1), comprising the following steps:
a. inserting a single source plate made of melamine resin foam into a burling machine;
b. compressing the source plate between two burl drums of the burling machine;
c. cutting the source plate in the compressed state by means of at least one cutting knife into at least two plates (10, 20) having burled surfaces (12, 22); and
d. adhering the at least two plates (10, 20) at the surfaces (12, 22), by an adhesive layer (30).
